(19) United States
(12) Patent Application Publication
(10) Pub. No.: US 2014/0309002 A1
(43) Pub. Date: Oct. 16, 2014

(54) GAME SYSTEM USING MODIFYING FACTORS TO ALLOCATE GAME PIECES IN A GAME OF CHANCE

(71) Applicant: Neal O'Gorman, Naas (IE)

(72) Inventor: Neal O'Gorman, Naas (IE)

(21) Appl. No.: 14/115,354

(22) PCT Filed: May 3, 2012
(86) PCT No.: PCT/IB2012/052223

§ 371 Date: Jul. 2, 2014

Related U.S. Application Data
(60) Provisional application No. 61/482,198, filed on May 3, 2011.

(51) Int. Cl. A63F 13/40

(52) U.S. Cl. CPC A63F 13/10; A63F 2300/6027
USPC 463/7; 463/10

(57) ABSTRACT

A system, method, and apparatus for allocating game pieces selected in a game of chance based on performance in a skill exercise, is disclosed. In one embodiment, the apparatus is a computing device such as a computer, mobile device, server, etc. that has a processor coupled to a an input/output device and to a memory, wherein the memory and processor implement a method of ranking, allocating, and distributing game pieces in a game of chance by: ranking a strength of each of the initial blind set of one or more game pieces; conducting a skill exercise amongst the players; ranking the players' input from the skill exercise; allocating the initial blind set to each player based on each player's performance on the skill exercise; distributing the initial blind set of one or more game pieces based on the allocating operation; and continuing with the game of chance.

### CROSS-REFERENCE TO RELATED APPLICATIONS

This application claims priority to US provisional application Ser. No. 61/482,198 filed May 3, 2011, entitled “GAME SYSTEM USING A SKILL EXERCISE TO REDISTRIBUTE GAME PIECES IN A GAME OF CHANCE.”

### FIELD OF TECHNOLOGY

This disclosure relates generally to a gaming method and system, and in one example embodiment, this disclosure relates to a method, apparatus and system of gaming that combines an element of skill with a game of chance.

### BACKGROUND

Most games, such as cards, that are played by hand or on the Internet involve primarily the element of chance. If the one or more decks are well shuffled, then it is up to chance, what hand each player will receive to start a game. After receipt of the initial dealing of a hand of cards, a player may then use judgment, intuition, a talisman, or superstition in analyzing her hand's strength against an unknown strength of one or more opponents' hands, and against remaining cards in a deck that might be dealt out to the one or more players. While games of chance provide entertainment, and a potential for gains in some cases, they remain essentially that: a game of chance. Additionally, players frequently spend substantial amounts of time playing games with the primary benefit of being entertained, socializing, passing time, attempting to win, etc. However, for a given game, the repetition of the rounds can become monotonous as the game rules do not change for a given game.

### SUMMARY

A method, apparatus, and system for game ranking, allocating, and distributing are disclosed. In one embodiment, the apparatus is a computing device such as a computer, mobile device, server, etc. that has a processor coupled to an input/output device and to a memory, wherein the memory and processor implement a method of drawing, ranking, allocating, and then distributing game pieces in a game of chance. In particular, the method includes the operations of: a chance dealing of an initial blind set of one or more game pieces for each player without distributing them to the players, yet ranking each of the initial blind set of one or more game pieces according to a strength based on a set of rules determined by the game of chance which rules are known by the players but which ranking is unbeknownst by the players in the game of chance; and creating a new distribution of, e.g., allocating each initial blind set of one or more game pieces to a respective player in the game of chance based on the ranking of each of the initial blind set of one or more game pieces and based on a factor other than the chance of game pieces in the game.

In one embodiment, the game pieces are playing cards, the initial blind sets of one or more game pieces is the blind hands of one or more cards drawn for the players prior to betting, and the creation of a new distribution, or allocation, of the initial blind sets of cards is based on a ranking of each of the sets and also from a ranking of each player from a skill exercise, such as a trivia question, a true/false question, a speed of a player's answer, a betting wager, a hand/eye coordination skill, etc. By adding a step of modifying the unknown and chance distribution of cards in the blind hand, based on a non-chance procedure, the interest level, the variations, the knowledge sharing, and the overall experience of the game of chance is improved and enhanced. By combining the skill exercise with a well-known type of game, training for the game is minimal and the variation of the combinations is essentially unlimited. With the present disclosure, good luck or bad luck can be tempered with a player's knowledge or skill. Similarly, a lack of knowledge or skill is not decisive, as an element of chance is still present in the game. Other factors can be used to enhance the game such as using a lifeline to answer a question, or buying/selling/trading tokens to improve a ranking in the skill exercise.

The game can be played by one or more players using communication devices such as laptop computers, mobile devices, etc., linked together via a network such as the Internet, and administered by an application, or app, server in the network that is managing the players and the game itself. In another embodiment, the game can be implemented on a single electronic device, or implemented by a dealer who draws the appropriate ‘physical’ cards, which are then ranked, and then distributed to the appropriate players with the aid of an electronic device, and where players are in proximity to each other and also can access the electronic device, e.g., a central unit with displays for each player, or separate individual devices for each player that are linked together. The electronic device manages the complexities of game such as rules, ranking, evaluating, and allocating and thereby allows the players to participate in the game of skill.

In addition, it will be appreciated that the various operations, processes, or methods disclosed herein may be embodied in a machine-readable medium and/or a machine accessible medium compatible with a data processing system (e.g., a computing device or system), and may be performed in different orders. Other features of the present embodiments will be apparent from the accompanying drawings and from the detailed description that follows. Accordingly, the specification and drawings are to be regarded in an illustrative rather than a restrictive sense.

### BRIEF DESCRIPTION OF THE VIEW OF DRAWINGS

Example embodiments are illustrated by way of example and not of limitation in the figures of the accompanying drawings, in which like references indicate similar elements and in which:

FIG. 1 is a functional block diagram of a gaming system that combines an element of chance with an exercise of skill, according to one or more embodiments.

FIG. 2 is a network system implementing a game having an element of chance with an exercise of skill, according to one or more embodiments.

FIG. 3 is a block diagram of a computing device for implementing a game having an element of chance with an exercise of skill, according to one or more embodiments.

FIGS. 4A and 4B are flowcharts of a method for gaming that combines an element of chance with an exercise of skill, according to one or more embodiments.

Other features of the present embodiments will be apparent from the accompanying drawings and from the detailed description that follows.

### DETAILED DESCRIPTION

A method, apparatus and system for gaming that combines an element of chance with an exercise of skill by ranking, allocating, and distributing game pieces in a game of chance based on a level of player skill is disclosed. In the following description, for the purposes of explanation, numerous specific details are set forth in order to provide a thorough understanding of the various embodiments. It will be evident, however to one skilled in the art that various embodiments may be practiced without these specific details.

### Function Block Diagram:

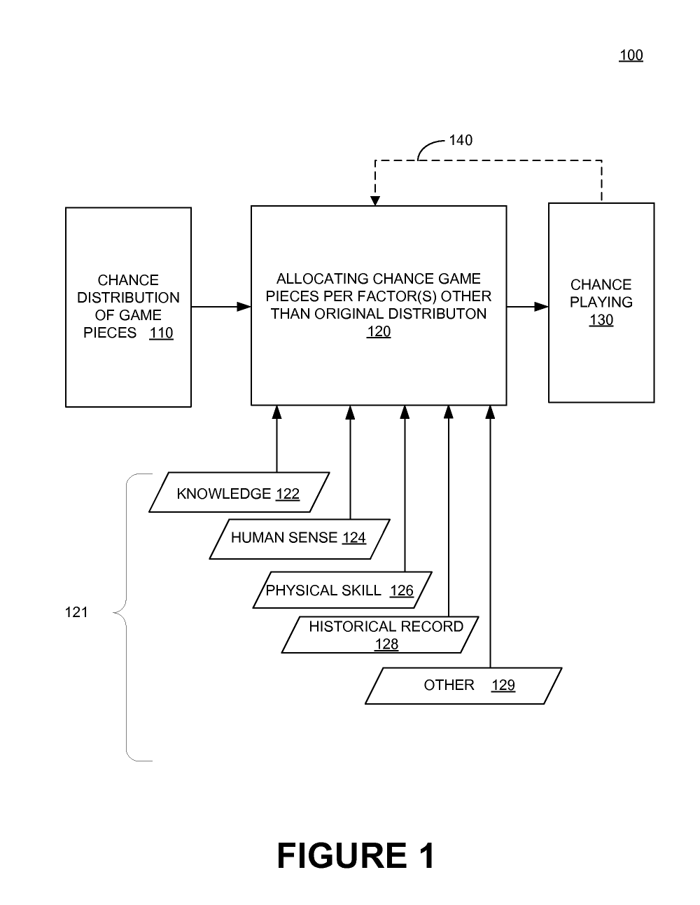

Referring now to FIG. 1, a functional block diagram 100 of a gaming system that combines an element of chance with an exercise of skill or knowledge is shown, according to one or more embodiments. Functions include a function of chance distribution of game pieces 110, e.g., in a game of chance; coupled to a function of allocating, or assigning, chance game pieces, or game resources, according to one or more modifying factors 121 (“factors”) where the factors 121 are other than the original function of chance distribution 110, e.g., other than pure chance such as drawing cards from an actual or virtual shuffled deck or shoe. Factors 121 can include knowledge 122, human senses 124, physical skill 126, historical record 128, e.g., handicap, or some other input 129 that is other than chance, or any combination thereof. In the present embodiment, the players are unaware of the content or ranking of the game pieces or the allocating, or reassignment, of the chance game pieces until after the modifying factors are implemented, after which the function of chance playing 130 continues. Other embodiments disclose one or more factors 120 in any combination or permutation to provide a different tack to the game, with associated changes in the atmosphere of the game, and presumed knowledge from the different factors disclosed. Repeat loop 140 can return to block 120 to allow a repeat of the allocation of game pieces per factors other than a chance distribution of game pieces of block 130. Repeat loop 140 can occur at different stages of the game or at different trigger events, to be determined by the creativity of the game designer.

Thus for example, disclosing the type of factor 121 to players, whether before the first bet, or after the first bet at some other strategic point in the game thereafter, e.g., that there was ‘some’ redistribution, or allocation, of game cards, while not disclosing which players received which ranking of game pieces provides one level of analysis by the players. That is, players can analyze or guess who got what game pieces, in an intellectual exercise that allows the player to process one or more of the types of factor 121, e.g., knowledge 122, along with any number of other criteria, such as personal experience with other players, gaming by other players, etc. In a practical example, an initial dealing might be allocated, or rearranged, in response to a question regarding a knowledge factor 122 asked of players to identify the fourth King of England. Say one player Joey, knows that another player Francisco, happens to be very good at history, but is confused because Francisco ran the clock, or bought extra time, to make his answer, unbeknownst to Joey for the purpose of deceptively appearing weak, e.g., sandbagging. Resultantly, both players may change their playing, betting strategy, etc. for this, or a future, round and/or game, resulting in an experience that is richer, more holistic and entertaining. From this example and a myriad of other conceivable combinations and permutations of procedures, rules, tactics, factors, etc., the present disclosure provides a gaming system having one or more orders of gaming dimensionality over standard gaming.

Functions of FIG. 1 are implemented in subsequent systems, apparatuses, and methods and their equivalents. The game of chance can be any game that where a distribution of game pieces can be ranked and then redistributed based on a skill exercise. Games of chance include, but are not limited to: card games such as poker, blackjack, baccarat, bridge, cribbage, rummy, sheepshead, etc; gambling games such as slot machines that can be coupled to each other for team playing, fantasy role-playing games (RPG) such as Dungeons & Dragons (D&D); game piece games such as dominos; board games such as Scrabble®, etc.

Functions of FIG. 1 can be implemented in other domains as well. For example, in the field of edutainment, where education is combined with entertainment, the combination of betting and knowledge, or skill-based input, can provide benefits to both the student and the education system. For example, a student having to wager on what they know or do not know, in order to answer a question, provides the student with a judgment skill of their assessment of themselves, along with the entertainment of the game. Also, a teacher or instructor may assign a weighting factor for different questions that might more appropriately reflect a given strategy of the teacher, whether it be rote memorization, application of skills and knowledge to a new problem type, cross-discipline applications, etc. Moreover, the repetition of exercises focused on weak skills, with appropriate levels of reward in betting odds, can help reinforce and improve the weak skill.

In yet another application, the present functions and implementations herein are applied to individual uses on a personal computer (PC) or to community-based uses such as a networked or cloud-based gaming group of action-adventure video game software associated with subjects such as: transportation, e.g., Grand Theft Auto™ (GTA), Flight Simulator, etc.; war-games and/or role-playing, e.g., World of Warcraft (WoW), etc.; Sci-fi, e.g., Halo, etc.; sports, e.g., Fantasy Football, skateboarding, etc.; children's games, e.g., Angry Birds, Mario Brothers' games, etc.; or any other type of game. The modifying factors for allocation of game pieces or resources can be related or unrelated to the given game theme. For example, GTA can present skill factors related to the automobile driving game at hand, e.g., dealing with automobile or engine facts or calculations, or with rules of the road, or GTA can present skill factors unrelated to the automobile driving game at hand, such as skill factors related to world history.

### Network and Computing Devices:

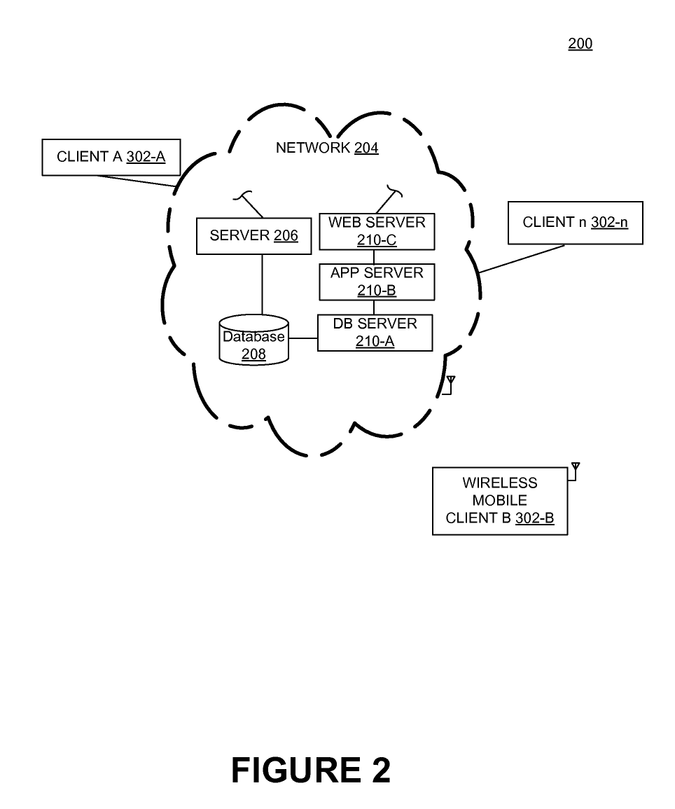

Referring now to FIG. 2, a network system 200 implementing a game that combines an element of chance with an exercise of skill is shown, according to one or more embodiments. In particular, system 200 includes a network 204 coupled via any type of network connection physical media, e.g., wired/wireless, optical/copper/etc., to one or more client, such as: Client A 302-A, e.g., a laptop computer, desktop PC, a notepad, a tablet, a dumb terminal, etc.; Client B 302-B, a wireless device, e.g., a mobile web-enabled cellular smart phone or other device with a communication link such as wireless fidelity (Wi-Fi) 802.11n, TDMA, GSM, CDMA, or other mode of wireless to base station or host connectivity; and client n 302-n, where n is any number of devices that can be supported by system 200. Network 204 can include any computing device that can administer the gaming system that combines an element of chance with an exercise of skill, such as one or more servers, e.g., server 206, and/or additional or substitute servers such as a specific web server 210-C for providing access to network 204, application (app) server 210-B for dedicated game and skill system application and administration, and database (DB) server 210-A, coupled to a database 208 for storing gaming, skill exercises, and player information such as historical performance, account information, points, trading, and other business models. Servers can be of any type operating on any language that provides ability to network clients with a hosted game system having an element of chance with an exercise of skill.

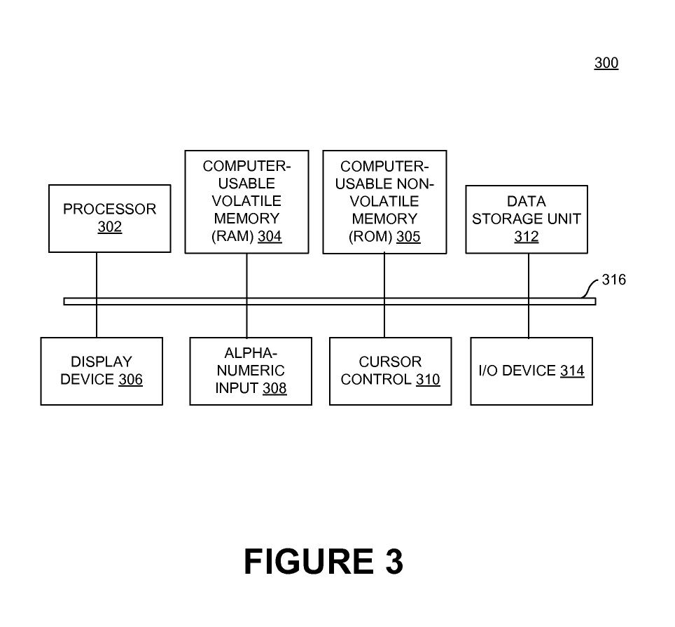

Referring now to FIG. 3, a representation of a computing device is shown, according to one or more embodiments. Exemplary computing device 300 includes components and functionality that can be applied to several devices in the system 200 such as a personal computer of client, e.g., client A 302-A, mobile device, e.g., client B 302-B, mobile computer, e.g., client n 302-n, minicomputer, mainframe, server, e.g., 206, 210-A through 210-C, etc. each of which are capable of executing instructions to accomplish the functions and operations described herein. Computing device 300 includes components such as a processor 302 coupled to a memory 304, 305, and/or 312. In particular, processor 302 can be a single or multi-processor core, for processing data and instructions. Memory 304, 305, and/or 312 are used for storing and providing information, data, and instructions, including in particular computer usable volatile memory 304, e.g. random access memory (RAM), and/or computer usable non-volatile memory 305, e.g. read only memory (ROM), and/or a data storage 312, e.g., flash memory, or magnetic or optical disk or drive. Computing device 300 also includes optional inputs, such as: alphanumeric input device 308, such as: a keyboard or touch screen with alphanumeric, function keys, object driven menus; a keypad button, a microphone with voice recognition software running on a processor, or any device allowing a player to respond to an input; or an optional cursor control device 310, such as a roller ball, trackball, mouse, etc., for communicating user input information and command selections to processor 302; or an optional display device 306 coupled to bus for displaying information; and an optional input/output (I/O) device 314 for coupling system with external entities, such as a modem for enabling wired or wireless communications between system and an external network such as the Internet, a local area network (LAN), wide area network (WAN), virtual private network (VPN), etc. Coupling medium 316 of components can be any medium that communicates information, e.g., wired or wireless connections, electrical or optical, parallel or serial bus, etc.

The computing device is only one example of a suitable computing environment and is not intended to suggest any limitation as to the scope of use or functionality of the present technology. The clients 302-A through 302-n can be smart devices, with sufficient processors, memory, graphics, and input/output (I/O) capabilities to operate their respective portion of the gaming software. Alternatively, clients 302-A through 302-n can be a thin client, e.g., a dumb device, which only has a capability or is only used to a capability of displaying results and accepting inputs. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

References to methods, systems, and apparatuses disclosed herein that are implementable in any means for achieving the various noted aspects, and may be executed in a form of a machine-readable medium, e.g., computer readable medium, embodying a set of instructions that, when executed by a machine such as a processor in a computer, server, etc. cause the machine to perform any of the operations or functions disclosed herein. Functions or operations may include dealing, ranking, creating, redistributing, conducting, evaluating, receiving, distributing, storing, identifying, retrieving, displaying, and the like.

The term “machine-readable” medium includes any medium that is capable of storing, encoding, and/or carrying a set of instructions for execution by the computer or machine and that causes the computer or machine to perform any one or more of the methodologies of the various embodiments. The “machine-readable medium” shall accordingly be taken to include, but not limited to, solid-state memories, optical and magnetic media, compact disc and any other storage device that can retain or store the instructions and information, e.g., only non-transitory tangible medium. However, the machine-readable medium can also include transitory signals in another embodiment.

As an alternative to a networked or personal computing device implementation, the gaming system that combines an element of chance with an exercise of skill can be implemented on a dedicated device, such as an ASIC-designed game device, or a multi-purpose gaming system, such as the WII®, Sony® PlayStation® PS3™, etc. coupled to a television or other display device.

### Process Flowchart and Case Tables:

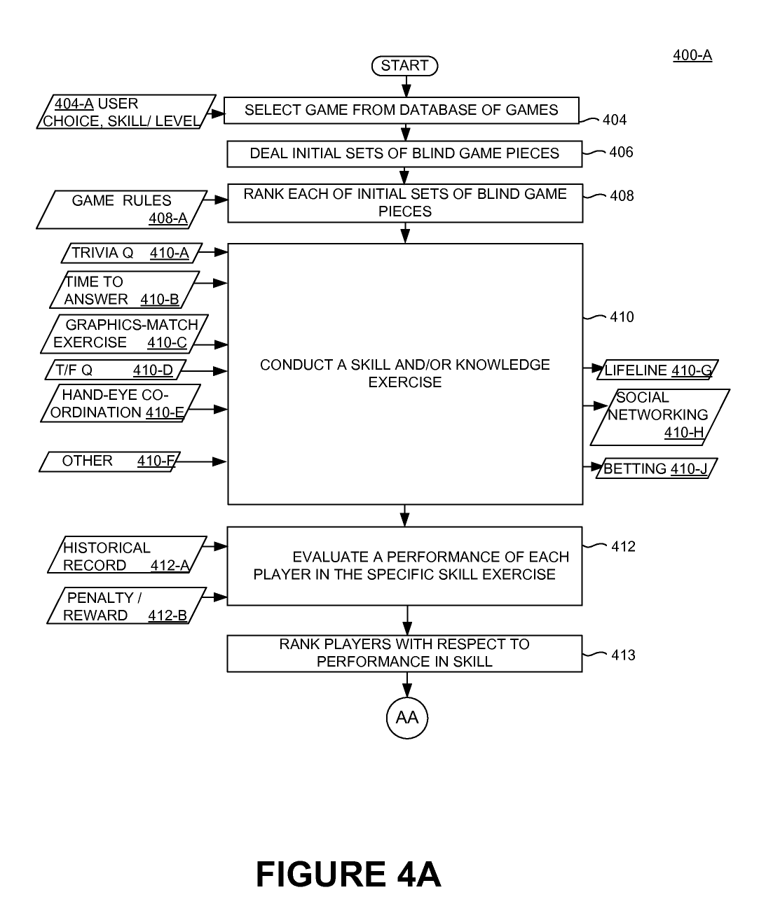

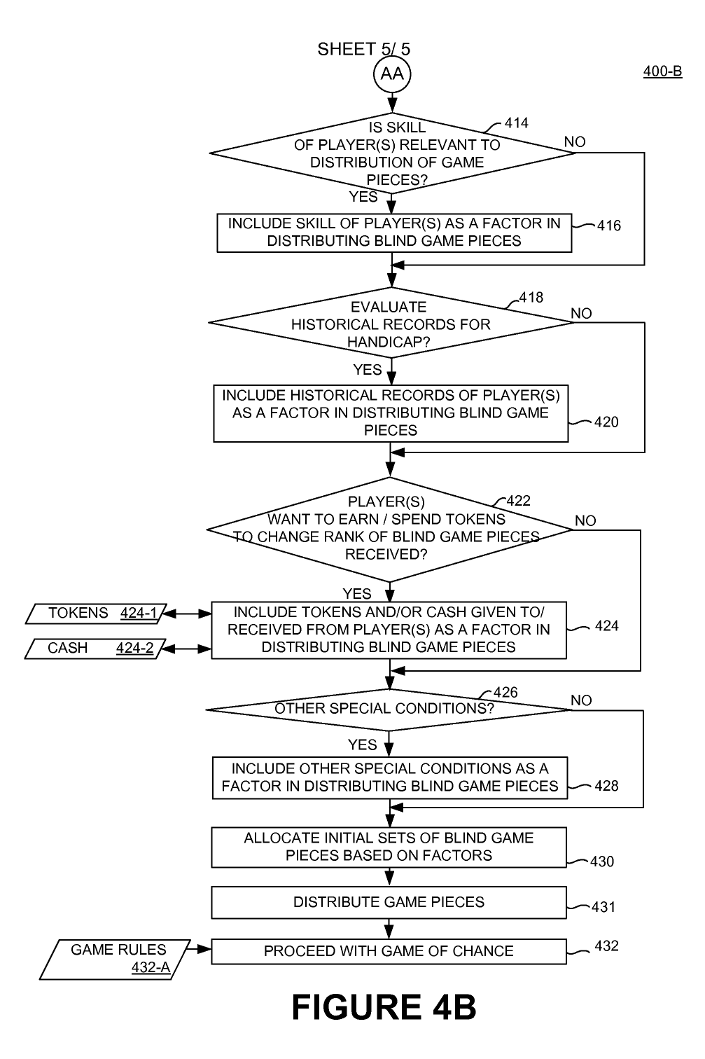

Referring now to FIGS. 4A and 4B, flowcharts 400-A and 400-B, respectively, of a method for gaming that combines an element of chance with an exercise of skill are shown, according to one or more embodiments. While flowcharts 400-A and 400-B can be implemented in a number of ways, such as with an electronic device or a physical card dealer, or by a mechanical device, the operational steps will be described herein as implemented on computing device 300 in system 200 in the present embodiment.

Additionally, operations of flowchart 400-A and 400-B will be applied to exemplary games of chance, skill exercises, hands of cards, and player choices, per the following tables. In particular, Tables 1-3 (“Tables”) are populated at different times by players: Frank, John, Bob, Jim, or Pauline (“Players”) who have picked a game for each table from an exemplary collection of games such as: Texas Hold'em Poker, Texas Ask'Em Poker, or Gin Rummy (“Games”). Table 3 implements Blackjack. Table 2 implements Texas Ask'Em™ Poker, a game title created for the present gaming system, where players have picked from planned skill exercises such as: multiple choice (“M/C”) trivia, word-answer trivia, and visual coordination (“Skills”). Table 1 implements Texas Hold'em™ Poker does not include Handicap statistics of players. Other forms of games include the “Ask'Em™” variety of games to denote the skill factor, e.g., Omaha Ask'Em™ Poker, Blackjack Ask'Em™, and Gin Rummy Ask'Em™.

TABLE 1
Level I Texas Ask'Em Poker with Multiple Choice Trivia.

| NAME | FRANK | JOHN | BOB | JIM | PAULINE |
|---|---|---|---|---|---|
| GAME CHOSE | <----------TEXAS HOLD'EM POKER -------------------------> | | | | |
| BLIND HAND | 10C, JC | AH, KD | 10S, JH | 2C, 8H | AC, AS |
| DEALT | | | | | |
| CARDS RANKED | 3 | 2 | 4 | 5 | 1 |
| M/C TRIVIA | Q: 43RD PRESIDENT OF USA? | | | | |
| | A) OBAMA B) BUSH C) CLINTON | | | | |
| | [B = Correct] | | | | |
| ANSWER | A | B | A | B | B |
| TIME TO | 2 | 2 | 3 | 1 | 3 |
| ANSWER (SEC) | | | | | |
| RANK PLAYER | 4 | 2 | 5 | 1 | 3 |
| SKILL | | | | | |
| REDISTRIBUTE | 10C, JC | AH, KD | 2C, 8H | AC, AS | 10S, JH |
| HANDS | | | | | |
| WINNER | TBD | TBD | TBD | TBD | TBD |
| FROM GAME | | | | | |
| OF CHANCE | | | | | |

TABLE 2
Level II Texas Ask'Em Poker with Multiple Choice Trivia Question Exercise:

| NAME | FRANK | JOHN | BOB | JIM | PAULINE |
|---|---|---|---|---|---|
| GAME CHOSEN | <-------------------TEXAS ASK'EM POKER ---------------------------- | | | | |
| | ---> | | | | |
| BLIND HAND | 10C, JC | AH, KD | 10S, JH | 2C, 8H | AC, AS |
| DEALT | | | | | |
| CARDS RANKED | 3 | 2 | 4 | 5 | 1 |
| TRIVIA | Q.: What date is the latest possible day for Easter Sunday? | | | | |
| QUESTION | A. April 25^{th} B. April 24^{th} C. March 22^{nd} D. April 28th | | | | |
| | [“A” = Correct] | | | | |
| ANSWER | NO | NO | Yes | NO | NO |
| LIFELINE? | | | | | |
| TIME BONUS | Yes | Yes | NO | NO | NO |
| USED? | | | | | |
| ANSWER | A | B | A | D | D |
| GIVEN | | | | | |
| TIME TO | 3.3 | 2.9 | 2.8 | 6.5 | 1.2 |
| ANSWER | | | | | |
| TIME BONUS | 1 | 1 | 0 | 0 | 0 |
| (SEC) | | | | | |
| TIME | 0 | 0.5 | 0 | 0 | 1.5 |
| PENALTIES: | | | | | |
| NET TIME | 2.3 | 2.4 | 2.8 | 6.5 | 2.7 |
| RANK PLAYER | 1 | 3 | 2 | 5 | 4 |
| SKILL | | | | | |
| REDISTRIBUTE | AC, AS | 10C, JC | AH, KD | 2C, 8H | 10S, JH |
| HANDS | | | | | |
| WINNER | TBD | TBD | TBD | TBD | TBD |
| FROM GAME | | | | | |
| OF CHANCE | | | | | |

TABLE 3
Black Jack with Physical Hand/Eye Coordination Skill Exercise:

| NAME | FRANK | JOHN | BOB | JIM | PAULINE |
|---|---|---|---|---|---|
| GAME CHOSE | <----------- BLACKJACK ----------------------------------> | | | | |
| BLIND HAND | Q, 9 | T, T | A, T | 2, 3 | J, 8 |
| DEALT | | | | | |
| CARDS RANKED | 3 | 2 | 1 | 5 | 4 |
| VISUAL | TAP AN OBJECT MOVING ACROSS TOUCH SCREEN | | | | |
| COORDINATION | [WINNER IS THE FASTEST AND MOST ACCURATE] | | | | |
| ANSWER | N/A | N/A | N/A | N/A | N/A |
| TIME TO | 0.3 | 1 | 3 | 1 | 3 |
| ANSWER (SEC) | | | | | |
| HANDICAP | HI | LO | MED | HI | LO |
| OTHER FACTOR | N/A | N/A | N/A | N/A | CHEATER |
| RANK PLAYER | 1 | 2 | 4 | 3 | 5 |
| SKILL | | | | | |
| REDISTRIBUTE | A, T | T, T | J, 8 | Q, 9 | 2, 3 |
| HANDS | | | | | |
| WINNER | TBD | TBD | TBD | TBD | TBD |
| FROM GAME | | | | | |
| OF CHANCE | | | | | |

Referring to FIG. 4A, flowchart 400-A begins with an operation 404 of selecting a game from a single game or a database of games, if available, based on optionally receiving, as user input 404-A, a selection of: a desired game to play from a list of available games; a desired skill test chosen from a list of available skill tests; and a player skill-level of the chance game and/or of the skill category. A default level, or random selection for levels or variables in the game can be provided by a computing device hosting the game, thereby optionally bypassing user input. Operation 404 is exemplified by Players using alpha-numeric input 308 per FIG. 3 on their devices of Client A 302-A through client n 302-n and as hosted on application, or app, server 201-B using database 208 per FIG. 3 to select respective games of Texas Hold'em poker, Texas Ask'Em Poker, and Black Jack, and to select multiple choice (m/c) trivia, trivia question, and visual coordination, at default skill levels, all of which are illustrated in Tables 1-3, respectively. In lieu of multiple players, a single player can play the game against the computing device, or the card dealer, as the ‘house,’ or where the other players are simulated by a computer, e.g., bots, if there aren't sufficient real persons participating as players

In operation 406, one or more game pieces are selected from a superset of game pieces, as defined by the particular game being played, to create blind sets of the one or more game pieces, e.g., one set for each player in the game of chance. The players are informed via a confirmation that at this point in the game, a set of one or more game pieces have been selected for them, though the game pieces remain with the host, or software application, and are not given to the players yet. In the present embodiment, the blind sets of one or more game pieces is the initial sets of game pieces for a given round of the game, but could alternatively be any distribution of game pieces at any point in time or any trigger event in a game. The selection is a random or pseudo-random process. The blind set of game pieces is only ‘virtually’ held by the dealer for the players, without actually being allocated, delivered or revealed to the players. The game pieces, e.g., cards, are held as a straw man dealing for the quantity of players in the present round of the game, until the set of game pieces are allocated to a specific player based on input from at least one of the players, or from each of the players. This operation 406 is implemented via an application, or app, server 201-B and database 208 acting as the dealer or the host for the operations herein. Alternatively, operation 406 is implemented on a computing device of a client, of FIG. 2, which together provide a discrete yet synchronized distribution computer program that is spread between clients that makes a pseudo-random or truly random selections between a number of choices, e.g., selecting the remaining cards in a deck(s) to deal a blind set of cards to the Players for Texas Hold-em poker, Texas Ask'Em poker and Black Jack per Tables 1-3, respectively. That is, if the computer program performing the selection is a program residing on local devices, e.g., clients 302-A, 302-B and 302-n, then the computer program is secured with encryption between players in a given virtual card table setting to prevent a player from altering a ranking outside the game rules or from learning information that other players do not receive, such as the identity of the game pieces selected, ranked or allocated in subsequent operations. The blind set means that players do not see the actual cards, but the cards have nonetheless been selected and are either left in a pool to be subsequently distributed after other factors are considered, or are temporarily assigned a given player. As an example, the row entitled “BLIND HAND DEALT” in Table 1 shows hands dealt, but not shown, to Frank, John, Bob, Jim and Pauline as a ten of clubs and a jack of clubs (10C, JC), an ace of hearts and a kind of diamonds (AH, KD), and a ten of spades and a jack of hearts (10S, JH), and a two of clubs and an eight of hearts (2C, 8H), and an ace of clubs and an ace of spades (AC, AS), respectively. Tables 2 and 3 show a dealing of blind hands this is performed similarly. These hands are stored in the memory of the app server 201-B or secretly held in the players' devices, e.g., 302-A, 302-B, or 302-n, and not yet released, or displayed, to client A 302-A through client n 302-n. Typically, the initial blind set of one or more game pieces is performed at the beginning of a game of chance. However, the present invention is well suited to utilizing the skill exercise to modify the chance distribution of game pieces for single or multiple occurrences in a game, and at any time in the game, or throughout the duration of a game, or to modifying any other chance aspect of a game, e.g., the rolling of dice via picking the best of a higher number of rolls for a higher performance in a skill exercise.

In operation 408, a ranking is performed of each of the initial blind set of one or more game pieces according to a strength based on a set of rules determined by the game of chance and unbeknownst to each player in the game of chance. Strength is based on the success of winning, considering the game pieces drawn for each player. As shown in Table 1, the row entitled “CARDS RANKED” indicates that Frank, John, Bob, Jim, and Pauline having hands ranked 3, 2, 4, 5, and 1, respectively. In the present embodiment, the set of game pieces remain together and are not distributed to the players until after the selecting, ranking, and allocating operations. Thus, Pauline would have normally had an initial advantage over the balance of the Players had the game continued with the blind hands as dealt. In another embodiment, the rankings of the different players can be revealed at different positions or stages of the game, e.g., in subsequent operations such as after a first or second bet, etc. In this manner, the nature of the game changes with the additional information presented at varying points in the game. For example if the responses of the different players is revealed to all players, a knowledgeable or skilled player may be able to discern whose answers are right and wrong, or at least more likely to be right or wrong, and thus infer a strength of an allocated group of game pieces to each player, thereby allowing the more knowledgeable or skilled player to bet accordingly, e.g., having a higher likelihood of knowing who is bluffing and who has a reasonable hand, though there is still some chance involved with the subsequent distribution or changing of game pieces.

However, subsequent operation 410 includes conducting a specific skill or knowledge exercise for at least one player, or for each player, in the game of chance, either randomly, in series, in parallel, round robin, etc. Each player in the game thusly inputs a response for the game via an input/output device 314, a cursor control 310, alphanumeric input 308, or a display device 306, e.g., with a touch screen, that is communicated by whatever communication link is available to the network 204, and ultimately to the host, or app server 210-B, or some similar method, as illustrated in FIGS. 2 and 3. For example, the skill exercise can test the knowledge of each player, a human sense of each player, or a physical skill of each player. Typically, all players participate in the same skill test, e.g., a homogenous inquiry, but in another embodiment, the skill tests are heterogeneous with different options such as a specific skill exercise for each player being chosen by the players themselves, or by another player, or randomly chosen by a computer. Some players can opt out by buying out, or using other points or resources to skip participation in a given skill or knowledge exercise. A knowledge tested of each player can include a trivia question (“Q”), per input 410-A that can be formatted as a true/false question (“T/F Q”) 410-D, a multiple-choice question (“M/C Q”), etc. Human senses and physical skill tests can include: eyesight and hand/eye coordination exercise 410-E; cerebral and motor skills portion of the brain; exemplified in skills such as picture matching exercise, or graphics-matching, 410-C (finding matching pairs of objects behind doors, finding differences in pictures, etc.), tagging a target on a screen, moving a joystick or cursor in a video/arcade against moving targets game exercise, selecting items in a sequence, etc.; and memory skills can include remembering sequences of numbers, objects, words, etc. The senses can also be skill tested in terms of speed of response, e.g., time to answer input 410-B, and accuracy of response, etc. Alternate games of skill include identification of songs or artists, picture identification, identifying famous people's picture and name, identifying a movie or television show from a played portion thereof. Indeed, any type of skill exercise that involves something other than the chance distribution of game pieces can be utilized to change the distribution of blind set of game pieces. Input from each player can be by an alphanumeric input 308, cursor control 310 or I/O device 314 of FIG. 3.

Other skill exercise input 410-F can include a musical chairs scenario for younger players presented as the traditional game in graphics on a viewing screen, e.g., a display device 306 of FIG. 3 including sound for playing music playing. When the music stops, the players all try to click on one of the seats on the screen, with there being one less seat than the quantity of players. If a first player selects a seat that was already picked by another player, then the first player must try on another seat, and so on. The player with no seat is then indicated as the lowest ranked player. The process repeats until only one chair is left with party selecting it and the other party losing. Similar other skill games for younger players can be adapted to an electronic format then interlaced within any game of chance. Examples of games include an electronic form of checkers for two players, or video games such as Space Invaders™, Pac Man™, etc.

Another option during the skill exercise operation 410 includes an optional output from players called a lifeline 410-G. As shown in Table 2, in row entitled “ANSWER LIFELINE?” player Bob did not know the answer and after 2.8 seconds, he was the only player that clicked on a Lifeline option, either as granted according to the rules of the game, or as won or purchased by the player. Thereafter, the answer based on the lifeline was revealed as the correct answer, though this is not guaranteed, and his time was set at the 2.8-second point.

Output 410-H provides a social networking output feature. When players like a question or a skill test, they are able to share it amongst their friends on a social media website or network, e.g., Facebook™, using a ‘like’ button provided on the display. Players can invite their friends to play and win more chips or tokens and rewards in doing so. If the answer to the question presented in operation 410 is given immediately after the skill exercise in one embodiment, then players know if they answered correctly, and thus will have additional knowledge about the strength of their hand after any allocation of hands and the subsequent revelation of the hand. Optionally, a player may not learn the answer to the question, relying instead on her own confidence in her answer. Alternatively, the statistics of all the players can be provided to all players, e.g., that two out of five players answered correctly. If players do not agree to the answer to a question, they can dispute it—with a request to other friends for consensus. If they are right, then they win additional chips or resources. Many different scenarios can be used for lifeline and for statistics relevant to players, e.g., players can pay or use tokens to find out stats for the current skill exercise. Centralized record keeping of scores, players, and statistics using app server 201-B and database 208 of FIG. 2 makes the fairness and communication between players.

Operation 412 involves evaluating a performance of each player in the specific skill exercise. A wide variety of evaluation paradigms can be used to rank the players' skill performance including optionally considering a historical record 412-A, or handicap, of varying lengths of time, e.g., past hand, current session, past timeframe performance, lifetime performance, etc. Other historical record inputs 412-A that can be considered include a record of the number of wins/losses, poor or good allocated set of game pieces, bad beats, where the loser received the winner's next number one ranked hand. Handicaps should consider all players' records consistently so as not to skew the game.

Another factor that can affect performance is a penalty/reward paradigm that can punish and/or reward a wide array of characteristics or attitudes of players. In general, correct answers are ranked first and incorrect answers are ranked next. Amongst a given category of responses, e.g., correct responses, the fastest player to answer in that category is ranked first, with the slowest one ranked last. Thus, in one embodiment, the fastest correct answer is first, and the slowest correct answer is last followed immediately in rank by the fastest wrong answer and with the overall last place ranking going to the slowest player that answered wrongly. Players having a wrong answer can be ranked randomly, so as not to reward fast responses from players who know they are wrong, but who answer quickly in an attempt to out game other players having a wrong answer.

The ranking of players is based on their answers optionally conditioned by the speed of their answers. The times for all players=actual time to answer+penalty/reward time 412-B, which can be an increase or a reduction of time in order to encourage or discourage certain types of behavior. For example, an increased time penalty or a decreased time reward can be determined based on the players previous selectable quantity of answers and the times to answer each of them.

One strategy is to discourage players from immediately guessing an answer as fast as possible with the hope that they are a good guesser and thereby receive a high placement based on their fast response. For example, a player might think that they have a 50% chance of a correct answer with a T/F question and a 25% chance of a correct answer with a four-answer multiple-choice question, so why not get an excellent time for the percentage of times they guess correctly. Thus, if a fast-guessing player selects response “A” in under 0.5 seconds for example—the system will judge that the time to respond would not even allow a reasonable player time to start reading the question. A single fast-guessing player will not be penalized as much as a consistent fast-guessing player will. Penalty times can place the guessing player after the player with the worst time for the same correct or incorrect answer category in which the guessing player landed. If a fast-guessing player reforms himself over subsequent hands, then the penalty time can be reduced as desired, e.g., by the system administrator through programmable settings in the game.

In another strategy, a player may use a bonus reward that he had previously won or acquired in order to reduce his time for a long response to a question that he found particularly difficult. A bonus reward can be acquired at various levels by inviting new or former players, and/or paying or non-paying players to the game. When a certain quantity or level of new players are invited by an existing player, the existing player then wins a time bonus. Alternatively, when a player completes a given quantity of hands, then they win a time bonus, a lifeline option, and/or other benefits. While a player has discretion to use the bonus time anyway they wish, a smart player would use the bonus time (a reduction of time for his answer) when he is certain his answer is correct, because otherwise the bonus time would be wasted on a wrong answer.

Chips, tokens, points or other game benefits, whether physical or virtual, are used in the game of chance being played. Thus, depending on the points system used, players can win more of these points through successful performance in the game of skill. A player can win chips that go to his account but the system will not take chips from him. The exception to this is the scenario where the skill element is replaced by a hidden bidding system that commits the player to the bet at the time of the hidden bidding.

In another embodiment, each answer has a weighting factor where some answers are considered more wrong than other answers are. Thus, the wrong players are first sorted by which answer they gave and for equal answers; multiple players are then ranked randomly. Thus, for example, if a player selects as a 43^{rd} president of the United States, a person who was never even a president, or perhaps never even an American, then that player is punished, e.g., placed at the bottom of the queue with all other wrong guessing players being randomly ranked above the dolt player, because their wrong answers were at least plausible.

In yet another embodiment, players within the game can purchase or win a time bonus reward; —and the player can select to use this option after answering their question to improve their answer time. Players can also select a ‘Lifeline’ option, if they have earned or acquired one, or been granted one to help compensate for lack of experience; where the Lifeline automatically provides the right answer or provides an answer with a higher probability of being correct.

An optional learning-round prior to the game can be provided as an edutainment tool to help players learn and increase their knowledge base. A learning-round would quickly run through a summary of a subject, e.g., run through the list of 38th through the 44th president of US, but would not identify the question to be asked, e.g., who is the 43rd president. A logical player to a question regarding the 43^{rd} president would still be able to reason an answer based on the limited amount of information he received ruing the learning-round, e.g., the learning round identified the 38^{th}-42^{nd}, and the 44^{th} president, therefore a player would be able to guess more easily the 43^{rd} president, knowing the other presidents before and after him. Players or administrators will have an opportunity to create their own questions and answers and to create their own private topic rooms where they supply the questions and invite only their friends to play. This will allow teachers to have a room based on the topic they teach and invite their colleagues and pupils to play for fun!

A player with a correct answer can also be rewarded with chips, or tokens, that are lodged into their account or into the game itself. Alternatively, a side pot can be created based on a percentage of the pot that goes to the player that was correct and fastest and is still in the hand at the ‘showdown’. In a final exemplary embodiment, players are allowed to bet on the answer and on whom was fastest, e.g., players can be out of their poker hand but still take part in betting that they were fastest and correct, with similar poker betting rules apply.

In operation 413, the ranking of each player participating in the game of chance occurs according to the performance of each player in the specific skill exercise, where the performance is the factor other than the chance of the initial blind set of one or more game pieces. For example, Table 1 indicates in row entitled “RANK PLAYER SKILL” that Jim has taken the #1 hand based on his correct answer of “B” in one (1) second. Similarly, Table 2 indicates that player Frank has won the ranking based on his correct answer of “A” in 3.3 seconds, which isn't the fastest correct answer, but when taken together with the time bonus of minus one (−1) second, and with zero time penalties, provides him with a ‘NET TIME’ of 2.3 seconds and the #1 pole position for receiving the best ranked blind hand. Operation 413 is not a random or pseudo-random process in the present embodiment, as it is known to the computer or the dealer, and is based on the rules of the game.

In operation 414, an inquiry determines whether the skill of the players is relevant to the distribution of the game pieces with only a positive response proceeding to operation 416 where the skill of players is included as a factor in distributing the blind game pieces. Similarly, in operation 418, an inquiry determines whether to evaluate a historical record for handicap for determining distribution of the present game pieces, with only a positive response proceeding to operation 420 that does in fact include the historical records of player(s) as a factor in distributing blind game pieces. Once more, in operation 422, an inquiry is made to determine whether any players wish to earn or spend tokens to change the rank of the blind game pieces, with only a positive response proceeding to operation 424 where tokens, chips, 424-1 and/or cash 424-2, are exchanged between players, e.g., clients, and the host game system.

A betting output 424-1 by one or more player could also be implemented in the game of chance. For example, players may vie for the best-ranked hand by placing the highest bid. The bid can be blind or open, and can be a single round or repeated round with an optional limitation on number of rounds. No bid is required to continue playing in one embodiment. However, as the cards haven't been shown yet, an element of chance still exists as to the strength of the best hand versus the second and third best hands, which might be very closely ranked, and thus making the game a very closely called game. The player that contributes the highest bid is ranked first, the player with the second highest bid is ranked second, and any players that bet the same will be randomly ranked to differentiate them.

In operation 426, an inquiry determines whether other special conditions should be considered in distributing blind game pieces. A positive response to operation 426 proceeds to operation 428 where the special conditions are included as a factor in distributing blind game pieces. For example, in Table 3 Pauline has been identified in the row entitled “OTHER FACTOR” as being a ‘cheater’ per metrics and/or evaluation of the players' behaviour. Consequently, Pauline will be penalized or disqualified for the given round, and potentially for future hands or games. Many other factors can be added to the evaluation of operation 426 to provide a clean and fair gaming system that promotes good behaviour between the players, and consequently protects the reputation of the game.

In operation 430 the creation of a new allocation, or assignment, of the initial blind set of one or more game pieces between each player in the game of chance based on the ranking of each of the initial blind set of one or more game pieces and based on a factor other than the chance of the initial blind set of one or more game pieces. The factor other than the chance of the initial blind set of one or more game pieces between each player in the game of chance is based on a ranking of each player from a skill exercise, wherein the ranking and redistributing of the initial blind set of one or more game pieces is known and manipulated by the processor and memory, but is unbeknownst to each player in the game of chance in the present embodiment. This feature of combining the uncertainty of a game of chance with the potential certainty of a skill factor provides another dimension to an otherwise well-known game. It also has the potential to balance the two and open the opportunity for skill sets of a player to help compensate or improve the aspect of luck, be it good or bad. Thus, the popularity of a known game of chance should increase and appeal to a wider audience for a potentially longer period of time, thereby increasing playership, loyalty, and the potential for revenue generation. Said another way, the present disclosure is gaming that differentiates the playing field for nerds, jocks, brains, gamblers, guessers, fakers, know-it-alls, actresses, historians, etc. in any combination, depending on the skill exercise, where any of these groups can incorporate into a game of chance, a skill that they possess, which would thereby be a potential catalyst to improve their odds of winning. And thus, while differentiating the field, the present disclosure also levels the playing field for the groups of players mentioned above who can rely on some of the skills tested in order to compete with other players who otherwise are more skilled at just gaming or who are inordinately lucky in a game of chance without any skill input outside the game of chance. In another embodiment, like-minded people can play together in a given game where the game of skill relates to their common interest, e.g., mathematicians playing in a given game setting having math questions as the skill exercise.

In practice, operation 430 aggregates the factors from operations 416, 420, 424, and 428 and combines them, with optional weighting factors for each, as provided by a game designer or system administrator, to provide a final cumulative ranking position. Thus, in Tables 1, 2, and 3, the resultant skill exercise and other factors combine to create a new distribution of the ranked set of game pieces amongst the players where a different player receives the number one ranked blind hand. In particular, the tables illustrate the number one ranked blind hand originally dealt to Pauline for Table 1, Pauline for Table 2 (at a different time), and Bob for Table 3, respectively, though none of them knew it at the time of dealing. Operation 430 is effectuated by app server 210-B applying the factors and rules described herein to the blind hands originally dealt and now stored in memory, e.g., of app server 210-B, and communicating the newly redistributed hands to the respective players on their respective communication device, e.g., 302-A, 302-B, or 302-n of FIG. 3, via the mode of communication linking them, e.g., wireless, cable, Internet, etc. Thus, in Table 1, the ranked blind hands communicated to players would be: number one to Jim, number two to John, number three to Pauline, number four to Frank, and number five to Bob. Similar operations occur in the subsequent tables. Allocation operation 430 is not the same as discarding poor game pieces, e.g., bad cards, in a hand of poker, for example. Rather, no additional game pieces are introduced in the present embodiment of operation 430 which keeps the same pool of sets of game pieces, whether they are the initial, intermediate or final deal of game pieces, and redistributes or more accurately, allocates the sets to the respectively ranked players. In another embodiment, a higher skill ranking could provide other benefits such as an opportunity to discard and replace game pieces, e.g., to replace poor tile selection in a word-creation game.

As a complete start-to-finish example of the preceding steps for Table 2, the bonuses and penalties are applied to the card game of chance called Texas Ask'Em Poker. Assuming five (5) players are in the game: Frank, John, Bob, Jim, and Pauline, they are each dealt a blind hand of cards whose identity is not identified. They then partake in the skill exercise of a trivia question asking, “What date is the latest possible day for Easter Sunday in any calendar year? A. April 25^{th}, B. April 24^{th}, C. March 22^{nd}, or D. April 28^{th}?” While everybody proceeds to answer, with his or her respective times, Bob decides after 2.8 seconds, that he does not know the answer and that he needs to call his lifeline, of which he had only one available. The answer provided by the lifeline happens to be the correct answer. The response time is chosen as the time at which Bob decided to call on the lifeline: 2.8 seconds. No other player chooses a lifeline. The fact that Bob used a lifeline can either be revealed to the other players either at the end of the skill exercise, at the end of the game, or never at all. After answering, two players, Frank and John, use an available time bonus of −1-second (off their response time) after selecting their answers at 3.3 and 2.9 seconds, respectively. Finally, two players have answered very quickly in previous hands and are suspected by the software of trying to ‘game’ the system. Because of this, they have picked up time penalties, with John receiving a 0.5-second penalty and Pauline receiving a 1.5-second penalty. After taking all the time bonuses and penalties and answers into account, the system concludes that the players are ranked in the following order: Frank, Bob, John, Pauline and finally Jim. Thus, the players receive respectively ranked hands from the blind hand dealt, e.g., first ranked Frank receives the first ranked blind hand, and so on.

Operation 431 allocates, or distributes, each of the ranked sets of game pieces to a given player. This only occurs in the present embodiment after the performance of the skill exercise operation of 410. While the prior operations have been performed surreptitiously, and unbeknownst to the players in one embodiment, or selectively revealed in different degrees, or completely revealed, to the players in other embodiments, the present operation 431 executes the distribution of game pieces to players for their exclusive viewing, whether they be cards, dominoes, credits, virtual weapons, or other resources used to advance a given player's chance of winning in the present game, or a series of games. The allocation operation 431 can also either provides all, some, or no indication of the player's performance in the skill exercise. Operation 431 is not a totally random or pseudo-random process, but a quasi-random or para-random process, or more appropriately a hybrid random/skill process, as it is known to the computer or the dealer, and is based on the aggregate factors of the original chance dealing of game pieces, the skill input by the players, and the rules of the game.

After the allocation operation 430, operation 432 returns to the original game of chance, e.g., only chance per the game's traditional rules and based not a skill exercise, upon which the players expected to play, e.g., Texas Hold-em™ poker, traditional poker, and Black Jack per Tables 1, 2, and 3, respectively. The game now proceeds as normal, with the app server 201-B utilizing rules and game piece management stored in memory of app server 201-B or in database 208. The resultant winner of each game is to be determined (TBD) by playing out the balance of the game. In another embodiment, the skill exercise can be repeated in a given game after the dealing and redistribution of the original hand of game pieces, such as for example, when the distribution of new game pieces is needed. If multiple players were to take a ‘hit’ of one or more new cards the dealing of that round of cards could likewise be ranked and redistributed, sometimes with the knowledge of the players' current hand. In this scenario, redistributing cards in a round of hits could make all players' rank higher because one player's bad card would be another player's good card.

Revealing information about: the original distribution of hands; the redistribution of hands of game pieces; the answers and performance for the skill exercise; and other data, can take on many different formats for what information gets revealed when and to whom. As a default, none of the players would know the rank of their originally dealt blind hand or the changes resulting from the redistribution, unless the game rule was structured to provide it as default or as a trade for a token or cash.

As a default, a player's answer to the skill exercise is provided to him along with his response time. In another embodiment, each player is told whether she was right or not immediately after the skill exercise is completed. In yet another embodiment a player is only told whether he was correct or not at the end of the hand when the answer is revealed to the group.

Statistics about the group's performance in the skill exercise can likewise take on many flavours. For example, in one embodiment, the fastest response time from the group can be revealed without identifying the respondent. In another embodiment, all the player's times and answers can be anonymously revealed. If a player has to show his hand (his poker hand) then he has to show his answer and his time to answer also, thus, for example if the game of chance was poker, keeping with the spirit of poker by revealing the winner's cards, and by revealing the winner's time and answers in the skill exercise.

### Alternatives

In another embodiment, a group of players are playing a variation of the classic slot machines or ‘one armed bandits,’ however all machines are networked together. Each person is presented with a game of skill and the players are thus accordingly ranked relative to each other. Prior to this, the server has randomly ‘dealt’ the first two columns of the slot machine game that has been selected for each player. The server has reviewed each pair of columns and has determined the ranking of all based on which one will most likely return the most money to the winning player. Each player is then assigned their initial two (2) columns and then the remaining columns are displayed on all screens. Any player that matches three (3) or more symbols (or whatever the rules of the particular game are) will win money. All players are in a position to win the money but the person that was ranked highest will have the best chance of winning the most money.

In yet another embodiment, the set of operations for dealing, altering and allocating of game pieces based on a factor other than chance that requires an input from each player, can be performed at some point other than the original or first dealing of the set of game pieces. For example, it can be performed at a later dealing or trading of game pieces, either once or multiple times, thereby adding more variations in the possible combinations of playing experiences for the players, and thus more entertainment, and either more or less predictability depending upon the desired circumstances.

While the present embodiment refers to the set of game pieces as being blind, in another embodiment, the game pieces are not blind, but are only partially blind, e.g., dealing one card up and one card down, and in yet another embodiment, all the game pieces are displayed, and none are blind, with either case having a temporal aspect, that displayed cards are only momentarily shown such that players only receive a passing glimpse. The last embodiment would clearly indicate to all players what cards are on the table, and thus players would compete more vigorously to answer a question, knowing the prize of the top hand is up for grabs.

References to methods, operations, processes, systems, and apparatuses disclosed herein that are implementable in any means for achieving various aspects, and may be executed in a form of a machine-readable medium, e.g., computer readable medium, embodying a set of instructions that, when executed by a machine such as a processor in a computer, server, etc. cause the machine to perform any of the operations or functions disclosed herein. Functions or operations may include selecting, ranking, altering, allocating, conducting, evaluating, receiving, and the like, with a verb, e.g., count, being equivalent to the transitive verb version, e.g., counting.

The term “machine-readable” medium includes any medium that is capable of storing, encoding, and/or carrying a set of instructions for execution by the computer or machine and that causes the computer or machine to perform any one or more of the methodologies of the various embodiments. The “machine-readable medium” shall accordingly be taken to include, but not limited to, solid-state memories, optical and magnetic media, compact disc and any other storage device that can retain or store the instructions and information, e.g., only non-transitory tangible medium. The present disclosure is capable of implementing methods and processes described herein using transitory signals as well, e.g., electrical, optical, and other signals in any format and protocol that convey the instructions, algorithms, etc. to implement the present processes and methods.

The computing system is only one example of a suitable computing environment and is not intended to suggest any limitation as to the scope of use or functionality of the present technology. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The present disclosure is applicable to any type of network including the Internet, an intranet, and other networks such as local are network (LAN); home area network (HAN), virtual private network (VPN), campus area network (CAN), metropolitan area network (MAN), wide area network (WAN), backbone network (BN), global area network (GAN), or an interplanetary Internet.

In an alternative embodiment, process 400-A and 400-B is implemented in a classical in-person card room setting wherein players sit at a table, and an initial blind set of game pieces, or cards, are dealt to each player. An optically visible area of the card table on which the initial cards are dealt detects via camera and optical character recognition, the cards and suits of each of the blind set of game pieces dealt. A computer or alternatively, a person, can view and rank the blind set of game pieces for strength according to the rules of the game. Players can then be asked a question or a skill exercise with their input hierarchically ranked based on accuracy, relevancy, or performance metric. Based on each of the players' respective input, the blind set of game pieces are allocated to each player by some recognizable means, such as having a light, an indicator, or some other label that signifies which player receives which blind set of game pieces.

Additional examples of skills to be evaluated from players can include, amongst others, learning to learn, reading, writing, computation, communication skills, oral skills, listening, problem-solving, creative thinking, self-esteem, motivation/goal setting, employability/career development, group effectiveness, interpersonal, lying and deception, negotiation and teamwork, influence, organizational, leadership, academic skills, logic, critical thinking, comprehension, analytic, math, listening, nonverbal communication, motor skills, creativity, innovation, music, arts, and crafts, perception, persuasion, procedural memory, knowledge, expertise, fluency, etc. While the present disclosure seeks a true random game playing experience with the game of chance, if the randomness is implemented using hardware, software, firmware, or some other scientifically created means, then the random generator may perform in more of a pseudorandom behavior than truly random. The more randomness and the less repetition or predictability in the system, the more the game appears as a game of chance, and the more desirable it is in general.

While a given set of game pieces remains together during the operations ranging from the selecting, ranking, and allocating operations, in another embodiment, the sets may be broken up to build better and worse sets of game pieces to further polarize the results of the game.

Methods and operations described herein can be in different sequences than the exemplary ones described herein, e.g., permutations. Thus, one or more additional new operations may be inserted within the existing operations or one or more operations may be abbreviated or eliminated, according to a given application, so long as substantially the same function, way and result is obtained.

Although the present embodiments have been described with reference to specific example embodiments, it will be evident that various modifications and changes may be made to these embodiments without departing from the broader spirit and scope of the various embodiments.

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to explain the principles and practical application of the invention and to enable others skilled in the art to better utilize the invention. It is intended that the scope of the invention be defined by the Claims appended hereto and their equivalents.

1. A computer comprising:
a processor for processing instructions;
an input/output device to display results and receive input; and
a memory coupled to the processor and input/output device, the memory for storing data;
wherein the computer is configured to:
select a set of one or more game pieces for each player from a superset of game pieces according to chance;
rank each set of one or more game pieces, according to a strength based on rules of the game of chance to create a ranked set of one or more game pieces for each of the players;
alter a likelihood of winning for at least one player depending on a factor other than chance that requires an input from each of the players that is unrelated to the one or more game pieces; and
allocate each of the ranked set of one or more game pieces to a given player in the game of chance based on the input from each player.

2. The computer of claim 1 wherein the operation to allocate of the ranked set of one or more game pieces to each player in the game of chance is dependent upon a ranking of each player from the factor that requires the input from a player.

3. The computer of claim 1 wherein the factor is a skill exercise.

4. The computer of claim 3 wherein the computer is further configured to:
conduct the skill exercise for each player in the game of chance;
evaluate a performance of each player in the skill exercise; and
rank each player participating in the game of chance according to the performance of each player.

5. The computer of claim 3 wherein the skill exercise is selected from a group consisting of a knowledge of each player, one of the human senses of each player, and a physical skill of each player.

6. The computer of claim 3 wherein the skill exercise is selected from a group consisting of a trivia question, a true/false question, a multiple-choice question, a picture matching exercise, and a hand/eye coordination exercise.

7. The computer of claim 1 wherein the factor other than chance is a historical record of one or more players in the game of chance.

8. The computer of claim 1 wherein the computer is further configured to:
receive a selection of a desired game to play from a list of available games; and
receive a selection of a desired skill exercise to evaluate from a list of available skill exercises.

9. The computer of claim 1 wherein a result from the operation to rank and alter the set of one or more game pieces for each player is unbeknownst to each player in the game of chance.

10. The computer of claim 1 wherein the ranked set of one or more game pieces are one or more cards.

11. The computer of claim 1 wherein the game of chance is a card game consisting of poker, blackjack, baccarat, bridge, cribbage, or rummy.

12. The computer of claim 1 wherein the computer is further configured to:
distribute each ranked set of one or more game pieces to a given player in the game of chance based on the operation to allocate.

13. The computer of claim 12 wherein the game of chance continues based on chance after the operation to distribute the ranked set of one or more game pieces.

14. A system comprising:
a server having a processor, a memory, and an input/output device coupled to each other;
a database stored in the memory; and
a client having a processor, a memory and an input/output device, wherein the client is coupled to the server via a network connection;
wherein the system is configured to:
select a set of one or more game pieces according to chance for each player in the game of chance;
rank each set of one or more game pieces according to a strength based on rules of the game of chance wherein a result of the operation to rank is unknown to players in the game of chance; and
allocate the set of one or more game pieces between each player in the game of chance based on the ranking of each of the set of one or more game pieces and based on a factor other than the chance of selecting the set of one or more game pieces.

15. The system of claim 14 wherein the operation to allocate the set of one or more game pieces between each player in the game of chance is based on a ranking of each player from a skill exercise.

16. The system of claim 15 wherein the method implemented on the processor and the memory further includes:
conduct the skill exercise for each player in the game of chance;
evaluate a performance of each player in the skill exercise; and
rank each player participating in the game of chance according to the performance of each player.

17-24. (canceled)

25. A method of playing a game of chance on a device having a processor coupled to a memory and an input and output device, the method comprising:
receiving confirmation that a set of one or more game pieces have been selected for a given player from a superset of game pieces;
receiving an instruction for the given player to perform a skill exercise;
inputting a response for the skill exercise by the given player to a host managing the game;
receiving a ranked set of one or more game pieces for the given player, as allocated from all the ranked sets of one or more game pieces for players in the game based upon a factor other than chance; and
playing at least a portion of the game of change by using the ranked set of one or more game pieces.

26. The method of claim 25 wherein the allocation of the ranked set of one or more game pieces is based on a ranking of the given player amongst the players based on the response to the skill exercise.

27. The method of claim 26 wherein the skill exercise tests a knowledge of the given player.

28. The method of claim 26 wherein the skill exercise tests a human sense of each player.

29-33. (canceled)
